(19) United States
(12) Patent Application Publication
(10) Pub. No.: US 2026/0273323 A1
(43) Pub. Date: Sep. 17, 2026

(54) Process for Treating Mercury Contaminated Waste for Landfill Disposal

(71) Applicant: Veolia ES Technical Solutions, L.L.C., Boston, MA (US)

(72) Inventors: Adam Bruner, Salt Lake City, UT (US); Ivan Labaye, Montreal (CA)

(21) Appl. No.: 19/077,883

(22) Filed: Mar. 12, 2025

(51) Int. Cl. A62D 3/38; B09B 1/00; C01G 13/00; A62D 101/43

(52) U.S. Cl. CPC A62D 3/38; B09B 1/00; C01G 13/00; A62D 2101/43

(57) ABSTRACT

A process is provided for stabilizing previously treated mercury containing residue that includes free mercury. At least some of the free mercury in the mercury containing residue is converted to black cinnabar which yields a chemically stabilized residue. Thereafter, the chemically stabilized residue is physically stabilized. Subsequently, the chemically and physically stabilized residue is subjected to a compounding process where the chemically and physically stabilized residue is integrated with a polymer material to form a compounded material.

### FIELD OF THE INVENTION

The present invention relates to processes for treating mercury contaminated waste, and more particularly to processes aimed at treating mercury contaminated waste for disposal in landfills.

### BACKGROUND OF THE INVENTION

Mercury contaminated waste is a serious environmental and public health concern because mercury is a toxic, heavy metal that can accumulate in ecosystems and the food chain. When improperly disposed of, mercury can leach into soil and ground water and enter water bodies, where it is converted to highly toxic compounds that build up in fish and shellfish. Humans, especially pregnant women and young children, who consume mercury contaminated seafood risk neurological and developmental damage. Mercury exposure can also harm wildlife, causing reproductive and behavioral issues in birds and mammals. Additionally, industrial emissions and improper disposal of products like batteries, thermometers, and fluorescent bulbs can contribute to widespread mercury contamination.

Developing and implementing processes for the safe disposal of mercury contaminated waste has long been and continues to be a challenge. This is due, in part at least, to the persistent toxicity of mercury and the fact that mercury does not degrade in the environment. Mercury contaminated waste has been disposed in landfills. However, disposing of mercury contaminated waste in landfills presents several challenges due to mercury toxicity, volatility, and long-term environmental risk. Standard landfills are not designed to safely contain mercury over long periods, and even specialized hazardous waste landfills require strict monitoring and contaminant measures to prevent leaks. The Resource Conservation and Recovery Act (RCRA) sets strict regulations for the disposal of mercury contaminated waste in landfills to minimize environmental and health risks. The necessity for highly restrictive and vigorously enforced regulations are obvious.

Even with these challenges, disposal of mercury contaminated waste in landfills remains a viable option. However, one substantial challenge lies in developing processes for the disposal of mercury contaminated waste in landfills that are cost effective, reliable, safe and environmentally sustainable.

### SUMMARY OF THE INVENTION

The present invention entails a process for treating a previously treated mercury containing residue including a free mercury concentration exceeding regulatory limits for landfill disposal. For convenience, the reference to “previously treated mercury containing residue including free mercury” is sometimes referred to herein as “mercury waste”. To treat and prepare the mercury waste for landfill disposal, the free mercury (in certain instances referred to as residual free mercury) is reacted with sulfur under controlled conditions to convert at least some of the free mercury to black cinnabar, forming a chemically stabilized residue. The term “chemically stabilized residue” simply conveys that at least some of the free mercury has undergone a stabilization reaction, transforming it into a less volatile and less mobile form (black cinnabar). Thereafter, the chemically stabilized residue is physically stabilized. After physically stabilizing the chemically stabilized residue, the process entails subjecting the stabilized residue to a compounding process where the stabilized residue is integrated with a polymer material to form a compounded material.

In one embodiment, the present invention entails a process for treating and preparing a previously treated mercury containing residue including free mercury for landfill disposal, comprising:

chemically stabilizing the free mercury in the mercury containing residue by reacting sulfur with the free mercury to convert at least a portion of the free mercury to black cinnabar which forms a chemically stabilized residue;

physically stabilizing the chemically stabilized residue; and

In another embodiment, the present invention entails a process for treating and preparing a previously treated mercury containing residue that includes a free mercury concentration greater than 0.025 ppm for landfill disposal, comprising:

reducing the concentration of the free mercury in the mercury containing residue by reacting sulfur with the free mercury and converting at least a portion of free mercury to black cinnabar, forming a chemically stabilized residue;

physically stabilizing the chemically stabilized residue;

subjecting the chemically and physically stabilized residue to a compounding process where the physically and chemically stabilized residue is integrated with a polymer material to form a compounded material; and

Other objects and advantages of the present invention will become apparent and obvious from a study of the following description.

### DESCRIPTION OF EXEMPLARY EMBODIMENTS

The present invention is a process for treating and preparing a mercury waste for disposal in a landfill. Waste treated by the process of the present invention is a pre-treated mercury containing residue that includes free mercury. There are many forms and types of pre-treated mercury containing residues. One example is red cinnabar (HgS, trigonal mercuric sulfide or trigonal mercury (II) sulfide). The present invention entails a process for reducing the free mercury concentration in the mercury containing residue to below regulatory limits for landfill disposal. This is achieved by converting at least some of the free mercury in the mercury containing residue to black cinnabar. This forms a chemically stabilized residue. In some instances, the physically stabilized residue is referred to as a chemically stable matrix. Thereafter, the chemically stabilized residue is subjected to a process that physically stabilizes the residue. Subsequently, the chemically and physically stabilized residue is subjected to a compounding process where the residue is integrated with a polymer material to form a compounded material. As discussed below, in one embodiment the compounded material can be disposed in a landfill along with an alkaline media placed in close proximity to the compounded material.

RCRA sets strict regulations for the disposal of mercury contaminated waste in landfills to minimize environmental and health risks. Under the RCRA, mercury contaminated waste is classified as a hazardous waste and must be managed according to specific treatment and disposal standards. Based on RCRA guidelines for land disposal of hazardous waste, mercury contaminated waste must be treated to what is referred to as the land disposal regulatory limit (LDR). LDR limits also designate that non-treatment processes, such as dilution, iron addition, etc., are not acceptable methods of reaching LDR limits for landfill disposal. While simply encapsulating mercury contaminated waste in plastic reduces leachability for mercuric sulfide waste, residual free mercury is not treated as it is only wrapped in plastic. As such, the simple encapsulation of a mercuric sulfide waste is not likely an acceptable “treatment” for mercuric sulfide waste intended to be disposed in a landfill. If, however, the mercury contaminated waste is retorted to a limit of 0.20 ppm residual free mercury, it may meet the retort limit for LDR. In such cases, encapsulation may be acceptable and additional treatment may not be necessary as the mercury contaminated waste has been treated to the regulatory requirement. However, there are drawbacks and disadvantages to relying on retorting to treat mercury contaminated waste. As a practical matter, retorting is an expensive and a complicated process, and as an option for dealing with mercury contaminated waste, is difficult to justify. Typically, retorting involves heating the mercury contaminated waste in a vacuum or controlled environment to vaporize and capture the mercury which thereafter sometimes requires purification. The remaining treated waste may still require additional stabilization before disposal.

Based upon existing treatment standards and requirements for disposal of mercury contaminated waste, the present invention is based upon post-treatment of mercury materials which have already been converted to a mercury containing residue, or, for example, mercuric sulfide (as red cinnabar). Initial treatment, such as retort mercury recovery, typically have residues above 0.20 ppm leachable mercury and do not meet the LDR standard. As such, they currently require either subsequent retort to 0.20 ppm or subsequent treatment to 0.025 ppm.

Mercury containing residues treated by the present process have previously undergone treatment. But still, the free mercury concentration of the pre-treated residues is typically above 0.20 ppm, which is substantially higher than the LDR limit for landfill disposal. As discussed below, the present process is based on chemical stabilization of free mercury as the main primary treatment, and in the case of landfill disposal, this requires reducing the free mercury concentration in the residue below 0.025 ppm. As discussed below, chemical stabilization is followed by physical stabilization which is followed by a compounding process where the treated residue is integrated into a polymer material.

The process begins with treating a previously treated mercury containing residue having a free mercury concentration higher than regulatory limits for landfill disposal. The first step in the process of preparing the mercury containing residue for landfill disposal is to chemically stabilize the free mercury in the residue. Chemically stabilizing the free mercury in the mercury containing residue is achieved by reacting sulfur with the free mercury under controlled conditions to convert at least some of the free mercury to black cinnabar. In one example, the reaction is carried out with a molar ratio of sulfur to mercury of approximately 1.0-1.3 and at an elevated pH of 9 or higher. This reaction is generally a solid phase reaction that is facilitated by small amounts of 1-3 wt-% existing moisture in the reaction materials. It is noted that the sulfur and free mercury reaction is closely controlled to prevent the destabilization of any other mercury compound (i.e. other than black cinnabar) in the residue. The product or resultant of reacting sulfur with the free mercury in the mercury containing residue is sometimes referred to as a chemically stabilized residue. Through the reactions of sulfur with the free mercury and the conversion of at least some of the free mercury to black cinnabar, the concentration of free mercury in the chemically stabilized residue is reduced to a level that permits landfill disposal (below 0.025 ppm) under the LDR.

After a substantial portion of the free mercury has been converted to black cinnabar, the process moves to physically stabilizing the chemically stabilized residue. As people ordinarily skilled in the art appreciate, there are various means and approaches to physically stabilizing residues and materials in general. This is accomplished in one example by mixing a pozzolanic material, water and a calcium compound with the chemically stabilized residue to form a cementitious compound that binds the constituents of the chemically stabilized residue into a chemically stable matrix. A pozzolan is a material that, when mixed with water and calcium hydroxide (lime), for example, reacts to form compounds with cement-like properties. Examples of pozzolan materials include natural pozzolans, such as volcanic ash and pumice, and artificial pozzolans, such as fly ash, silica fume or ground granulated blast furnace slag.

According, the chemically stabilized residue can be physically stabilized by chemical fixation reactions through pozzolan structures.

Ca₂OH₂+Al₂O₃ -> Ca-Al-H species

Ca₂OH₂+Si₂O₂ -> Ca-Si-H species

After chemically stabilizing the free mercury and physically stabilizing the resulting treated residue, the process treats the resulting chemically stable matrix to prevent mercury from leaching from the matrix. Here, the concern is that pH-based destabilization and elevated temperatures have the potential to induce mercury leaching even after chemical and physical stabilization. So, to alleviate these concerns and to mitigate against leaching and destabilization, the process entails additional steps.

The chemically stable matrix resulting from the physical stabilization process is subjected to a compounding process where the chemically stable matrix is integrated with a polymer material to form a compounded material. There are various ways of compounding the chemically stable matrix with a polymer material. In one embodiment or one example, the chemically stable residue, along with the pozzolan material and calcium, are thoroughly mixed with a polymer material in a twin screw extruder. The extruder thoroughly mixes the constituents and produces an extrusion that includes constituents of the chemically stable matrix, as well as the polymer material. As noted above, the product of this process is referred to as a compounded material. The compounded material can be cut or broken into pellets for easy handling and transport.

Effective distribution and dispersion of the chemically stable matrix constituents are important to this compounding process. This is especially true because of the molecular size of some mercury compounds compared to the polymer chain of the compounded product. In addition, pozzolans, black cinnabar and other small particles benefit from the effective distribution and dispersion of the constituents of the compounded material. Also, it is noted that higher concentrations of the polymer matrix and mercury sulfide compounds natively provide reduced migration and leaching of mercury species by limiting mobility

The underlying rationale for polymer compounding relates to a number of factors. First, structural similarities between the plastic polymer and the long cinnabar chains offers improved compounding and blending to insure effective distribution. This reduces surface and migratory leaching. Furthermore, reduced water mobility through the polymer limits ion movement, effectively forming a barrier around the stabilized residue. As water and ion transfer is reduced, so is the destabilization potential. Finally, branching polymers are used for the compounding to serve as a molecular “net”, serving to hold the reagents and treated mercury containing residue in place. This serves as a polymer-based cage that partially limits the mobility of the long mercury sulfide molecules, as well as the pozzolanic treatment particles.

Finally, to further mitigate against leaching and pH destabilization, the present invention envisions that, along with the treated mercury containing residue, high pH media (i.e. media having a pH of 9.0 or higher) can be used to accompany the compounded material in the landfill. Landfill disposal with concurrent high pH media, such as alkaline-stabilized material, alkaline incinerator ash, lime treated materials (such as scrubber ash), serves to not only maintain the stabilization range of the chemical and physical stabilization treatments discussed above, but also to buffer environmental conditions that may result in pH changes. This insures high efficiency and longevity of the pozzolanic and chemical stabilization conditions by preventing back reactions. A pH of 9.0 or higher around the compounded material is sufficient to maintain stabilization in a landfill environment. Further, alkaline and high pH materials (pH of 9.0 or higher) serve to provide improved stabilization of the treated residue over other approaches, such as sealed containment. Although sealed containment provides a physical barrier, concurrent disposal of the compounded material with high pH materials provides chemical buffering of the stabilization.

In summary, the present invention discloses a process for treating a mercury containing residue that reduces free mercury concentrations below regulatory limits for landfill disposal. The overall process entails various subprocesses that offer significantly improved treatment and stabilization of a mercury containing residue that includes free mercury. These processes include:

Secondary chemical stabilization of free mercury in a previously treated mercury containing residue by converting the free mercury to black cinnabar, resulting in a chemically stable residue.

Physically stabilizing the chemically stable residue by the formation of pozzolanic compounds or other physical stabilizing compounds to form a chemically stable matrix.

Subjecting the chemically stable matrix to a compounding process where the chemical matrix is integrated with a polymer material to form a compounded material that limits or prohibits leaching of mercury.

High pH (9.0 and higher) landfill disposal to maintain chemical and physical stabilization conditions.

The present invention may, of course, be carried out in other specific ways than those herein set forth without departing from the scope and the essential characteristics of the invention. The present embodiments disclosed herein are therefore to be construed in all respects as illustrative and not restrictive and all changes coming within the meaning and equivalency range of the appended claims are intended to be embraced therein.

What is claimed is:

1. A process for treating and preparing a previously treated mercury containing residue that includes free mercury for landfill disposal, comprising:
a. chemically stabilizing the free mercury in the previously treated mercury containing residue by reacting sulfur with the free mercury to convert at least a portion of the free mercury to black cinnabar which forms a chemically stabilized residue;
b. physically stabilizing the chemically stabilized residue; and
c. subjecting the chemically and physically stabilized residue to a compounding process where the chemically and physically stabilized residue is integrated with a polymer material to form a compounded material.

2. The process of claim 1 wherein converting the free mercury in the mercury containing residue to black cinnabar includes reacting sulfur with the free mercury at a pH of at least 9.0.

3. The process of claim 1 wherein chemically stabilizing the free mercury in the mercury containing residue includes reacting sulfur with the free mercury at a molar ratio of S:Hg of approximately 1.0-1.3 and at a pH of at least 9.0.

4. The process of claim 1 wherein:
chemically stabilizing the free mercury in the mercury containing residue includes reacting sulfur with the free mercury at a molar ratio of S:Hg of approximately 1.0-1.3 and at a pH of at least 9.0; and
physically stabilizing the chemically stabilized residue includes mixing a pozzolanic material and a calcium compound with the chemically stabilized residue to form a cementitious compound that binds the chemically stabilized residue into a chemically stable matrix.

5. The process of claim 1 wherein chemically stabilizing the free mercury in mercury containing residue includes reducing the concentration of the free mercury below a selected limit.

6. The process of claim 1 wherein chemically stabilizing the free mercury in the mercury containing residue includes reducing the concentration of the free mercury in the chemically stabilized residue below 0.025 ppm.

7. The process of claim 1 wherein physically stabilizing the chemically stabilized residue includes forming the chemically stabilized residue into a cementitious compound.

8. The process of claim 1 including associating a high pH media with the compounded material wherein the high pH media includes media having a pH of at least 9.0.

9. The process of claim 1 including disposing the compounded material in a landfill and placing an alkaline media in close proximity to the compounded material in the landfill.

10. The process of claim 1 including placing the compounded material in a landfill and placing an alkaline-stabilized material, alkaline incinerator ash, or a lime treated material in the landfill in the vicinity of the compounded material.

11. The process of claim 1 wherein the mercury containing residue containing free mercury comprises red cinnabar.

12. The process of claim 11 wherein chemically stabilizing the free mercury in the red cinnabar is performed without destabilizing the red cinnabar.

13. A process for treating and preparing a previously treated mercury containing residue that includes a free mercury concentration greater than 0.025 ppm for landfill disposal, comprising:
a. reducing the concentration of the free mercury in the previously treated mercury containing residue by reacting sulfur with the free mercury and converting at least some of the free mercury to black cinnabar to form a chemically stabilized residue;
b. physically stabilizing the chemically stabilized residue;
c. subjecting the chemically and physically stabilized residue to a compounding process where the physically and chemically stabilized residue is integrated with a polymer material to form a compounded material; and
d. wherein as a result of the process, the concentration of free mercury in the compounded material is less than 0.025 ppm.

14. The process of claim 13 wherein reducing the concentration of the free mercury in the mercury containing residue includes reacting sulfur with the free mercury at a molar ratio of S:Hg of approximately 1.0-1.3.

15. The process of claim 13 wherein mixing the sulfur with the free mercury and converting at least some of the free mercury to black cinnabar is performed at a pH of 9.0 or higher.

16. The process of claim 13 wherein the mercury containing residue comprises red cinnabar and wherein chemically stabilizing the free mercury in the red cinnabar is performed without destabilizing the red cinnabar.

17. The process of claim 13 including disposing of the compounded material in a landfill and placing a media having a pH of at least 9.0 in the landfill and in the vicinity of the compounded material.
